(19) United States
(12) Patent Application Publication
(10) Pub. No.: US 2010/0131571 A1
(43) Pub. Date: May 27, 2010

(54) METHOD APPLICATION AND SYSTEM FOR CHARACTERIZING MULTIMEDIA CONTENT

(76) Inventor: Yoseph REUVENI, Petach Tikva (IL)

Correspondence Address: Professional Patent Solutions, P.O. BOX 654, HERZELIYA PITUACH, 46105, IL

(21) Appl. No.: 12/277,368

(22) Filed: Nov. 25, 2008

(51) Int. Cl. G06F 17/30; G06F 7/00

(52) U.S. Cl. 707/803; 707/E17.044; 707/E17.009; 707/E17.014

(57) ABSTRACT

Disclosed is a system, application and method for generating characterization information for multimedia content. According to some embodiments of the present invention, first characterization information for the content may be applied as a constraint on one or more recognition algorithms. The content may be analyzed using one or more recognition algorithms to generate second characterization information.

### FIELD OF THE INVENTION

The present invention relates generally to the field of digital communication. More specifically, the present invention relates to a method, application and system for characterizing multimedia content.

### BACKGROUND

With the enormous amount of image based content archived since human kind began producing images and later audio/video content (e.g. movies and TV shows), the searching of these archives has become a formidable task. Originally, in some cases, manually generated logs were used by content producers and/or owners. However, the manual generation of these logs and later searching of logs has proved both inefficient and for the most part ineffective.

With the proliferation of the digital multimedia and computerized databases, the tagging of image based and audio/video content, and later search/retrieval of tagged content, has become more practical. However, with the enormous volume of content already archived and due to the numerous parameters by which content (e.g. images, movies, movie scenes) may be characterized (e.g. scene actions, scene actors, objects in scene, clothes worn by actors in scene, sounds and words spoken in a scene, etc.) manually tagging audio/video multimedia content with metadata characterizing even a single scene in movie content is an enormously labor intensive task. Thus, it has been proposed to apply image recognition, also referred to as computer vision, and other (e.g. speech, action, etc) recognition algorithms/techniques and technologies to the task of searching large image based archives.

However, the field of computer vision can be characterized as immature and diverse. Even though earlier work exists, it was not until the late 1970s that a more focused study of the field started when computers could manage the processing of large data sets such as images. However, these studies usually originated from various other fields, and consequently there is no standard formulation of “the computer vision problem.” Also, and to an even larger extent, there is no standard formulation of how computer vision problems should be solved. Instead, there exists an abundance of methods for solving various well-defined computer vision tasks, where the methods often are very task specific and seldom can be generalized over a wide range of applications. Many of the methods and applications are still in the state of basic research, but more and more methods have found their way into commercial products, where they often constitute a part of a larger system which can solve complex tasks (e.g., in the area of medical images, or quality control and measurements in industrial processes). In most practical computer vision applications, the computers are pre-programmed to solve a particular task, but methods based on learning are now becoming increasingly common.

Content-based image retrieval (CBIR), also known as query by image content (QBIC) and content-based visual information retrieval (CBVIR) is the application of computer vision to the image/video retrieval problem, that is, the problem of searching for digital images in large databases. There is a growing interest in CBIR because of the limitations inherent in metadata-based systems, as well as the large range of possible uses for efficient image/video retrieval. However, CBIR has a drawback relating to the amount of processing power and time it requires to search even through a relatively small database of images and videos. This limitation may make CBIR impractical for real-time searching of large databases or archives. Additionally, CBIR is not applicable to movies, only to individual images.

Therefore, there is a need in the field of image based content archiving and retrieval for improved methods, applications and systems which can analyze, characterize and metadata tag multimedia content, making the content searchable using standard search term lookups.

### SUMMARY OF THE INVENTION

The present invention is a method, application and system for characterizing multimedia content. According to some embodiments of the present invention, one or more matching/identification/recognition algorithms may take into account known characterization information relating to multimedia content (e.g. metadata tags indicating various parameters of the content such as title, actors, etc.) when generating additional characterization information (e.g. metadata or characterization parameters) about the content. The known characterization information may be received with the content to be characterized, may be retrieved from an external database using search terms based on the characterization data received with the content, or may have been generated/derived by one of the one or more algorithms. Known characterization information may be used to tune, weight and/or otherwise constrain a given matching/identification/recognition algorithm according to some embodiments of the present invention. Characterization information generated by one of the one or more algorithms may be categorized as validated or unvalidated.

According to some embodiments of the present invention, unvalidated characterization information may be generated by the one or more algorithms during an initial matching/identification/recognition analysis iteration. The analysis during the initial iteration may be tuned, weighted and/or otherwise constrained by characterization information received with the content and/or retrieved from an external database. According to further embodiments of the present invention, any characterization information generated at a first point in time of the initial iteration may be used to tune, weight and/or otherwise constrain one or more algorithms at a later point in time of the first iteration.

According to a further embodiment of the present application, some or all of the one or more algorithms may be used to perform a second iteration of analysis on the content, during which second iteration unvalidated characterization information generated during the first iteration is either validated or invalidated. During the second iteration, some or all of the characterization information received with the content, retrieved from external sources and/or generated during the first iteration may be used to tune, weight and/or otherwise constrain one or more of the algorithms.

According to further embodiments of the present invention, content including more than one scene or more than one scene segment (e.g. several camera locations during the same scene) may be segmented such that boundaries between the scene/segments are defined and/or otherwise marked. The first, the second or both iterations of algorithmic analysis for characterization of the content may perform scene/segment segmentation and/or may take into account scene/segment boundaries for tuning, weighting and/or otherwise constraining analysis by one or more of the algorithms.

According to some embodiments of the present invention, there is provided: (1) a content receiving module adapted to receive multimedia content to be characterized; (2) a metadata extraction module adapted to extract any tags or metadata characterizing the content already present within the received content (e.g. title of movie or T.V. show, list of actors, titles of any music in the content, etc.); (3) an external database query module adapted to search one or more (external) database resources (e.g. google, flixter, etc.) for additional characterization information relating to the received content (e.g. if only the title of a movie/show is known, a list of characters and associated actors may be retrieved. Face images and voiceprints of known actors/characters may be retrieved, etc.); (4) one or more clusters of processing logic engines (e.g. processors) adapted to run one or more matching/identification/recognition algorithms adapted for: (a) Sound movement tracking (estimate object position), (b) Face recognition (try to match face to actors in the movie), (c) voiceprint recognition (i.e. speaker identification of who is speaking), (d) Object tracking (movement, position), (e) Speech recognition (speech to text conversion), (f) Sound effect recognition (identify explosions, aircraft, helicopter, etc.), (g) Object recognition (bottles, cans, cars, etc.), (h) Motion recognition (character movement, object movement, camera movements, etc); and (5) a data handling module adapted to receive characterization data from and to provide characterization data to the one or more algorithms (e.g. interface to database application including database with a database including tables to store characterization data received with the content, received from the global database(s), and generated by the one or more algorithms).

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a functional block diagram of a multimedia sharing system, including a content characterization/tagging system according to some embodiments of the present invention;

FIG. 2 is a functional block diagram of a content characterization/tagging system according to some embodiments of the present invention; and

FIG. 3 is a flowchart including the steps of an exemplary method of characterizing and tagging data according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of the most important protocols in it: the Transmission Control Protocol (TCP) and the Internet Protocol (IP), which were also the first two networking protocols defined. Today's IP networking represents a synthesis of two developments that began in the 1970s, namely LANs (Local Area Networks) and the Internet, both of which have revolutionized computing.

The Internet Protocol suite—like many protocol suites—can be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP reference model consists of four layers.

### Layers in the Internet Protocol Suite

The IP suite uses encapsulation to provide abstraction of protocols and services. Generally a protocol at a higher level uses a protocol at a lower level to help accomplish its aims. The Internet protocol stack has never been altered, by the IETF, from the four layers defined in RFC 1122. The IETF makes no effort to follow the seven-layer OSI model and does not refer to it in standards-track protocol specifications and other architectural documents.

| | |
|---|---|
| 4. Application | DNS, TFTP, TLS/SSL, FTP, Gopher, HTTP, IMAP, IRC, |
| | NNTP, POP3, SIP, SMTP, SNMP, SSH, TELNET, ECHO, RTP, |
| | PNRP, rlogin, ENRP |
| | Routing protocols like BGP, which for a variety of reasons |
| | run over TCP, may also be considered part of the application or |
| | network layer. |
| 3. Transport | TCP, UDP, DCCP, SCTP, IL, RUDP |
| 2. Internet | Routing protocols like OSPF, which run over IP, are also to |
| | be considered part of the network layer, as they provide path |
| | selection. ICMP and IGMP run over IP and are considered part |
| | of the network layer, as they provide control information. |
| | IP (IPv4, IPv6) |
| | ARP and RARP operate underneath IP but above the link |
| | layer so they belong somewhere in between. |
| 1. Network access | Ethernet, Wi-Fi, token ring, PPP, SLIP, FDDI, ATM, Frame Relay, |
| | SMDS |

Some textbooks have attempted to map the Internet Protocol suite model onto the seven layer OSI Model. The mapping often splits the Internet Protocol suite's Network access layer into a Data link layer on top of a Physical layer, and the Internet layer is mapped to the OSI's Network layer. These textbooks are secondary sources that contravene the intent of RFC1122 and other IETF primary sources. The IETF has repeatedly stated that Internet protocol and architecture development is not intended to be OSI-compliant.

RFC3439, on Internet architecture, contains a section entitled: “Layering Considered Harmful”: Emphasizing layering as the key driver of architecture is not a feature of the TCP/IP model, but rather of OSI. Much confusion comes from attempts to force OSI-like layering onto an architecture that minimizes their use.

Today, most commercial operating systems include and install the TCP/IP stack by default. For most users, there is no need to look for implementations. TCP/IP is included in all commercial Unix systems, Mac OS X, and all free-software Unix-like systems such as Linux distributions and BSD systems, as well as Microsoft Windows.

Unique implementations include Lightweight TCP/IP, an open source stack designed for embedded systems and KA9Q NOS, a stack and associated protocols for amateur packet radio systems and personal computers connected via serial lines.

According to some embodiments of the present invention, mobile devices may connect with and access data from an enterprise data system over a communication network at some portion of which may be a wireless network. While the term wireless network may technically be used to refer to any type of network that is wireless, the term is most commonly used to refer to a telecommunications network whose interconnections between nodes is implemented without the use of wires, such as a computer network (which is a type of communications network). Wireless telecommunications networks are generally implemented with some type of remote information transmission system that uses electromagnetic waves, such as radio waves, for the carrier and this implementation usually takes place at the physical level or “layer” of the network. (For example, see the Physical Layer of the OSI Model). Various wireless technologies and standards existing, including:
1. Global System for Mobile Communications (GSM): The GSM network is divided into three major systems which are the switching system, the base station system, and the operation and support system (Global System for Mobile Communication (GSM)). The cell phone connects to the base system station which then connects to the operation and support station; it then connects to the switching station where the call is transferred where it needs to go (Global System for Mobile Communication (GSM)). This is used for cellular phones, is the most common standard and is used for a majority of cellular providers.
2. Personal Communications Service (PCS): PCS is a radio band that can be used by mobile phones in North America. Sprint happened to be the first service to set up a PCS.
3. D-AMPS: D-AMPS, which stands for Digital Advanced Mobile Phone Service, is an upgraded version of AMPS but it is being phased out due to advancement in technology. The newer GSM networks are replacing the older system.
4. Wireless MAN—metropolitan area network.
5. Wireless LAN—local area networks.
6. Wireless PAN—personal area networks.
7. GSM—Global standard for digital mobile communication, common in most countries except South Korea and Japan.
8. PCS—Personal communication system—not a single standard, this covers both CDMA and GSM networks operating at 1900 MHz in North America.
9. Mobitex—pager-based network in the USA and Canada, built by Ericsson, now used by PDAs such as the Palm VII and Research in Motion BlackBerry.
10.GPRS—General Packet Radio Service, upgraded packet-based service within the GSM framework, gives higher data rates and always-on service.
11. UMTS—Universal Mobile Telephone Service (3rd generation cell phone network) based on the W-CDMA radio access network.
12.AX.25—amateur packet radio.
13.NMT—Nordic Mobile Telephony, analog system originally developed by PTTs in the Nordic countries.
14.AMPS—Advanced Mobile Phone System introduced in the Americas in about 1984.
15.D-AMPS—Digital AMPS, also known as TDMA.
16.Wi-Fi—Wireless Fidelity, widely used for Wireless LAN, and based on IEEE 802.11 standards.
17.Wimax—A solution for BWA (Broadband Wireless Access) and conforms to IEEE 802.16 standard.

Canopy—A wide-area broadband wireless solution from Motorola.

The present invention is a method, application and system for characterizing multimedia content. According to some embodiments of the present invention, one or more matching/identification/recognition algorithms may take into account known characterization information relating to multimedia content (e.g. metadata tags indicating various parameters of the content such as title, actors, etc.) when generating additional characterization information (e.g. metadata or characterization parameters) about the content. The known characterization information may be received with the content to be characterized, may be retrieved from an external database using search terms based on the characterization data received with the content, or may have been generated/derived by one of the one or more algorithms. Known characterization information may be used to tune, weight and/or otherwise constrain a given matching/identification/recognition algorithm according to some embodiments of the present invention. Characterization information generated by one of the one or more algorithms may be categorized as validated or unvalidated.

According to some embodiments of the present invention, unvalidated characterization information may be generated by the one or more algorithms during an initial matching/identification/recognition analysis iteration. The analysis during the initial iteration may be tuned, weighted and/or otherwise constrained by characterization information received with the content and/or retrieved from an external database. According to further embodiments of the present invention, any characterization information generated at a first point in time of the initial iteration may be used to tune, weight and/or otherwise constrain one or more algorithms at a later point in time of the first iteration.

According to a further embodiment of the present application, some or all of the one or more algorithms may be used to perform a second iteration of analysis on the content, during which second iteration unvalidated characterization information generated during the first iteration is either validated or invalidated. During the second iteration, some or all of the characterization information received with the content, retrieved from external sources and/or generated during the first iteration may be used to tune, weight and/or otherwise constrain one or more of the algorithms.

According to further embodiments of the present invention, content including more than one scene or more than one scene segment (e.g. several camera locations during the same scene) may be segmented such that boundaries between the scene/segments are defined and/or otherwise marked. The first, the second or both iterations of algorithmic analysis for characterization of the content may perform scene/segment segmentation and/or may take into account scene/segment boundaries for tuning, weighting and/or otherwise constraining analysis by one or more of the algorithms.

According to some embodiments of the present invention, there is provided: (1) a content receiving module adapted to receive multimedia content to be characterized; (2) a metadata extraction module adapted to extract any tags or metadata characterizing the content already present within the received content (e.g. title of movie or T.V. show, list of actors, titles of any music in the content, etc.); (3) an external database query module adapted to search one or more (external) database resources (e.g. google, flixter, etc.) for additional characterization information relating to the received content (e.g. if only the title of a movie/show is known, a list of characters and associated actors may be retrieved. Face images and voiceprints of known actors/characters may be retrieved, etc.); (4) one or more clusters of processing logic engines (e.g. processors) adapted to run one or more matching/identification/recognition algorithms adapted for: (a) Sound movement tracking (estimate object position), (b) Face recognition (try to match face to actors in the movie), (c) voiceprint recognition (i.e. speaker identification of who is speaking), (d) Object tracking (movement, position), (e) Speech recognition (speech to text conversion), (f) Sound effect recognition (identify explosions, aircraft, helicopter, etc.), (g) Object recognition (bottles, cans, cars, etc.), (h) Motion recognition (character movement, object movement, camera movements, etc); and (5) a data handling module adapted to receive characterization data from and to provide characterization data to the one or more algorithms (e.g. interface to database application including database with a database including tables to store characterization data received with the content, received from the global database(s), and generated by the one or more algorithms).

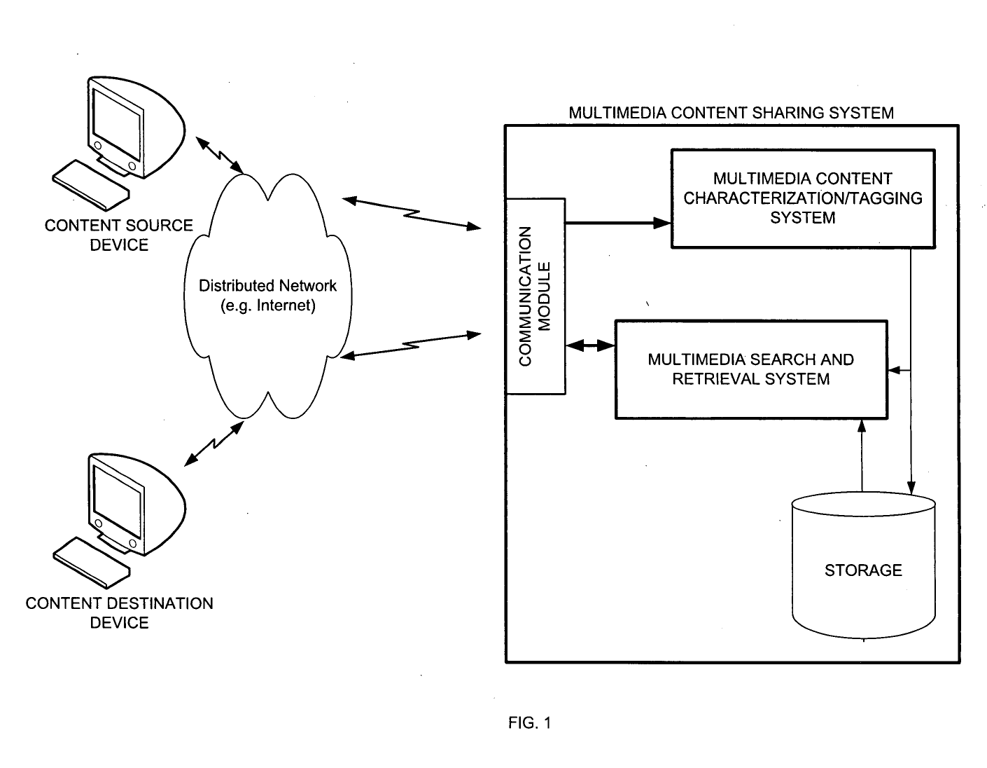

Turning now to FIG. 1, there is shown a functional block diagram of a multimedia sharing system (e.g. website), including a content characterization/tagging system according to some embodiments of the present invention. Multimedia content (movie or video clip) posted to the sharing system/site may be received from a content source device (e.g. computer of posting party) through the system's communication module and the content may be analyzed by the multimedia characterization/tagging system. Once characterized and tagged, the content may be stored on the sharing system's storage and tags regarding the content may be indexed and made searchable by the multimedia search and retrieval system.

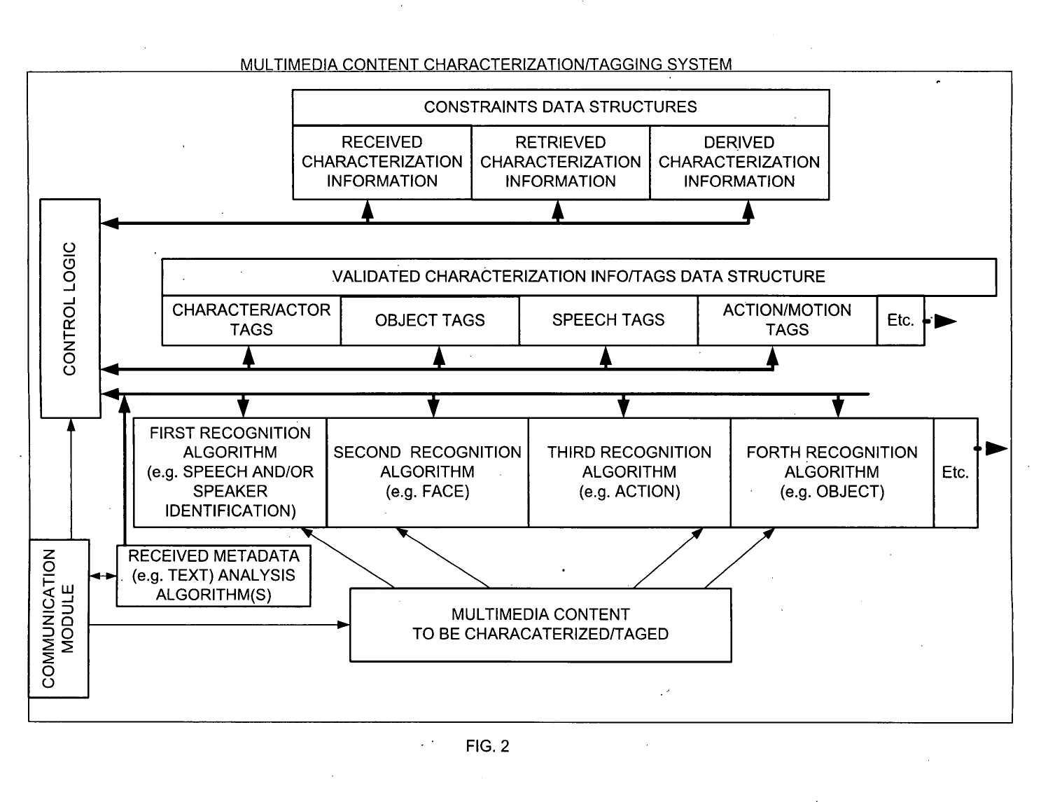

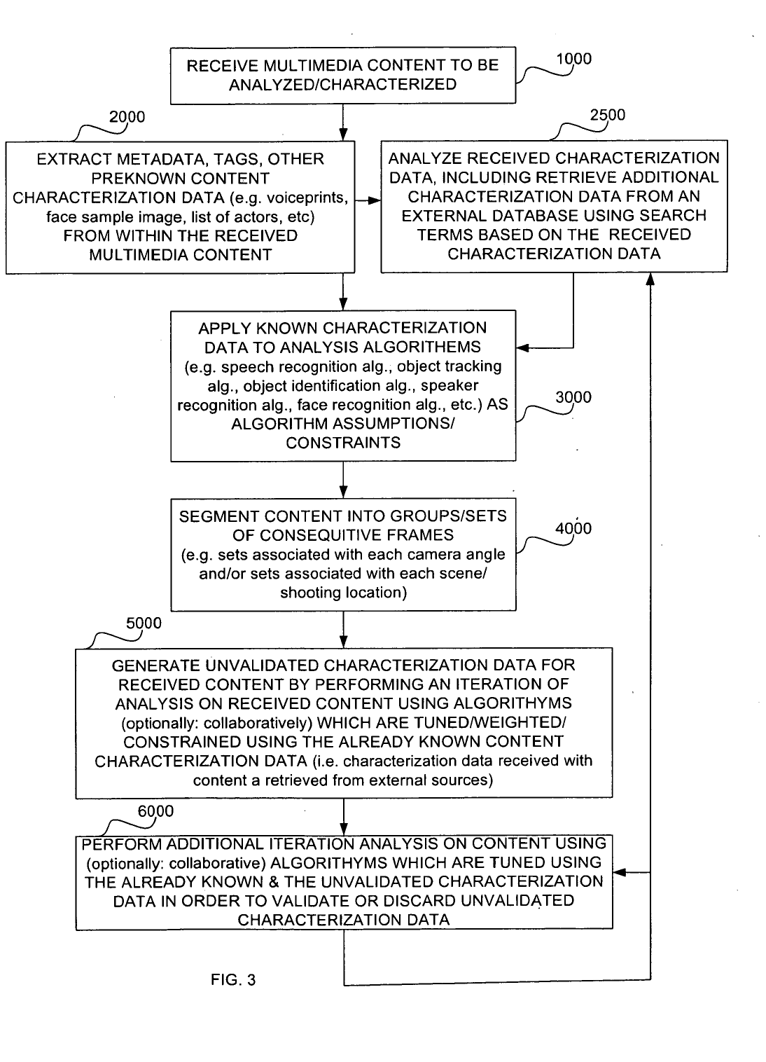

Turning now to FIG. 2, there is shown a functional block diagram of an exemplary content characterization/tagging system according to some embodiments of the present invention. The operation of the system of FIG. 2 may be described in conjunction with the flow chart of FIG. 3, which flowchart includes the steps of an exemplary method of characterizing and tagging data according to some embodiments of the present invention. The multimedia content may be received (step 1000) through the system's communication module (e.g. TCP-IP communication hardware, communication stack, etc.). Content characterization metadata received with the content may be extracted from the content (Step 2000) and analyzed (Step 2500) by metadata analysis algorithms, some of which algorithms may query one or more external data sources (e.g. databases) based on the received characterization metadata.

Received characterization data and the retrieved characterization data (known characterization data) may be stored and applied as weighting/constraining factors (Step 3000) to a set of recognition algorithms (e.g. speech recognition, face recognition, action recognition, object recognition, etc.) during an initial analytical iteration on the received content (Step 5000). Optionally, the content may be segmented (Step 4000) prior to the first analytical iteration. The first analytical iteration may produce a set of unvalidated characterization data, which unvalidated characterization data may be either validated or dismissed during subsequent analytical iterations (Step 6000). Validated characterization data may be saved as metadata tags of the received content. The validated characterization data may also be used to retrieve more characterization data from an external data source. It should be clear to one of ordinary skill in the art that analytical/recognition iterations may be repeated as many number of times as is practical given the operational/performance specifications of a system according to some embodiments of the present invention.

As previously explained, the output of one recognition algorithm may be used to constrain another recognition algorithm. Below is a table indicating some exemplary possible relationships between the output of one recognition algorithm of a first type being used as a constraint on another recognition algorithm of a second type:

Algorithm Type List:

1. Sound movement tracking (estimate object position)

2. Face recognition (try to match face to actors in the movie)

3. Voice pattern recognition (who is speaking)

4. Object tracking (movement, position)

5. Speech recognition (currently applicable only in English)

6. Sound effect recognition (like explosions, aircraft, helicopter, etc.)

7. Image recognition (bottles, cans, and more)

8. Motion (video) recognition (camera movements, etc.)

First Algorithm Output to Second Algorithm Constraint Relations Table

| | 1 | 2 | 3 | 4 | 5 | 6 | 7 | 8 |
|---|---|---|---|---|---|---|---|---|
| 1 | | | | X | | X | | X |
| 2 | | X | X | X | | | | |
| 3 | | X | | X | X | | | |
| 4 | X | X | X | | | X | X | X |
| 5 | | X | | X | | | X | |
| 6 | | | | X | | | X | X |
| 7 | | | | X | | | | |
| 8 | X | | | X | | | | |

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

### INCORPORATED REFERENCES

The following publications are hereby incorporated by reference in their entirety:
Dana H. Ballard and Christopher M. Brown (1982). Computer Vision. Prentice Hall. ISBN 0131653164.
Wilhelm Burger and Mark J. Burge (2007). Digital Image Processing: An Algorithmic Approach Using Java. Springer. ISBN 1846283795 and ISBN 3540309403.
J. L. Crowley and H. I. Christensen (Eds.) (1995). Vision as Process. Springer-Verlag. ISBN 3-540-58143-X and ISBN 0-387-58143-X.
E. R. Davies (2005). Machine Vision : Theory, Algorithms, Practicalities. Morgan Kaufmann. ISBN 0-12-206093-8.
Olivier Faugeras (1993). Three-Dimensional Computer Vision, A Geometric Viewpoint. MIT Press. ISBN 0-262-06158-9.
R. Fisher, K Dawson-Howe, A. Fitzgibbon, C. Robertson, E. Trucco (2005). Dictionary of Computer Vision and Image Processing. John Wiley. ISBN 0-470-01526-8.
David A. Forsyth and Jean Ponce (2003). Computer Vision, A Modern Approach. Prentice Hall. ISBN 0-12-379777-2.
Gösta H. Granlund and Hans Knutsson (1995). Signal Processing for Computer Vision. Kluwer Academic Publisher. ISBN 0-7923-9530-1.
Richard Hartley and Andrew Zisserman (2003). Multiple View Geometry in Computer Vision. Cambridge University Press. ISBN 0-521-54051-8.
Berthold Klaus Paul Horn (1986). Robot Vision. MIT Press. ISBN 0-262-08159-8.
Bernd Jähne and Horst Hauβecker (2000). Computer Vision and Applications, A Guide for Students and Practitioners. Academic Press. ISBN 0-13-085198-1.
Bernd Jähne (2002). Digital Image Processing. Springer. ISBN 3-540-67754-2.
Reinhard Klette, Karsten Schluens and Andreas Koschan (1998). Computer Vision—Three-Dimensional Data from Images. Springer, Singapore. ISBN 981-3083-71-9.
Tony Lindeberg (1994). Scale-Space Theory in Computer Vision. Springer. ISBN 0-7923-9418-6.
David Marr (1982). Vision. W. H. Freeman and Company. ISBN 0-7167-1284-9.
Gerard Medioni and Sing Bing Kang (2004). Emerging Topics in Computer Vision. Prentice Hall. ISBN 0-13-101366-1.
Tim Morris (2004). Computer Vision and Image Processing. Palgrave Macmillan. ISBN 0-333-99451-5.
Nikos Paragios and Yunmei Chen and Olivier Faugeras (2005). Handbook of Mathematical Models in Computer Vision. Springer. ISBN 0-387-26371-3.
Azriel Rosenfeld and Avinash Kak (1982). Digital Picture Processing. Academic Press. ISBN 0-12-597301-2.
Linda G. Shapiro and George C. Stockman (2001). Computer Vision. Prentice Hall. ISBN 0-13-030796-3.
Milan Sonka, Vaclav Hlavac and Roger Boyle (1999). Image Processing, Analysis, and Machine Vision. PWS Publishing. ISBN 0-534-95393-X.
Emanuele Trucco and Alessandro Verri (1998). Introductory Techniques for 3-D Computer Vision. Prentice Hall. ISBN 0132611082.
Karat, Clare-Marie; Vergo, John; Nahamoo, David (2007), “Conversational Interface Technologies”, in Sears, Andrew; Jacko, Julie A., The Human-Computer Interaction Handbook: Fundamentals, Evolving Technologies, and Emerging Applications (Human Factors and Ergonomics), Lawrence Eribaum Associates Inc, ISBN 978-0805858709 .
Cole, Ronald; Mariani, Joseph; Uszkoreit, Hans et al., eds. (1997), Survey of the state of the art in human language technology, Cambridge Studies In Natural Language Processing, XII-XIII, Cambridge University Press, ISBN 0-521-59277-1 .
Junqua, J.-C.; Haton, J.-P. (1995), Robustness in Automatic Speech Recognition: Fundamentals and Applications, Kluwer Academic Publishers, ISBN 978-0792396468.
U.S. Pat. No. 6,711,293, “Method and apparatus for identifying scale invariant features in an image and use of same for locating an object in an image”, David Lowe's patent for the SIFT algorithm
Lowe, D. G., “Object recognition from local scale-invariant features”, International Conference on Computer Vision, Corfu, Greece, September 1999.
Lowe, D. G., “Distinctive Image Features from Scale-Invariant Keypoints”, International Journal of Computer Vision, 60, 2, pp. 91-110, 2004.
Serre, T., Kouh, M., Cadieu, C., Knoblich, U., Kreiman, G., Poggio, T., “A Theory of Object Recognition: Computations and Circuits in the Feedforward Path of the Ventral Stream in Primate Visual Cortex”, Computer Science and Artificial Intelligence Laboratory Technical Report, December 19, 2005 MIT-CSAIL-TR-2005-082.
Beis, J., and Lowe, D. G “Shape indexing using approximate nearest-neighbour search in high-dimensional spaces”, Conference on Computer Vision and Pattern Recognition, Puerto Rico, 1997, pp. 1000-1006.
Lowe, D. G., Local feature view clustering for 3D object recognition. IEEE Conference on Computer Vision and Pattern Recognition, Kauai, Hi., 2001, pp. 682-688.
Lazebnik, S., Schmid, C., and Ponce, J., Semi-Local Affine Parts for Object Recognition, BMVC, 2004.
Sungho Kim, Kuk-Jin Yoon, In So Kweon, “Object Recognition Using a Generalized Robust Invariant Feature and Gestalt's Law of Proximity and Similarity,” Conference on Computer Vision and Pattern Recognition Workshop (CVPRW'06), 2006
Bay, H., Tuytelaars, T., Gool, L. V., “SURF: Speeded Up Robust Features”, Proceedings of the ninth European Conference on Computer Vision, May 2006.
Ke, Y., and Sukthankar, R., PCA-SIFT: A More Distinctive Representation for Local Image DescriptorsComputer Vision and Pattern Recognition, 2004.
Mikolajczyk, K., and Schmid, C., “A performance evaluation of local descriptors”, IEEE Transactions on Pattern Analysis and Machine Intelligence, 10, 27, pp 1615-1630, 2005.
Brown, M., and Lowe, D. G., “Recognising Panoramas,” ICCV, p. 1218, Ninth IEEE International Conference on Computer Vision (ICCV'03)—Volume 2, Nice, France, 2003
Li, L., Guo, B., and Shao, K., “Geometrically robust image watermarking using scale-invariant feature transform and Zernike moments,” Chinese Optics Letters, Volume 5, Issue 6, pp. 332-335, 2007.
Se, S., Lowe, D. G., and Little, J. J., “Vision-based global localization and mapping for mobile robots”, IEEE Transactions on Robotics, 21, 3 (2005), pp. 364-375.

What is claimed:

1. A method of generating characterization information for multimedia content comprising:
applying first characterization information for the content as a constraint on one or more recognition algorithms; and
analyzing the content using the one or more recognition algorithms to generate second characterization information.

2. The method according to claim 1, wherein the first characterization information is either received with the content or retrieved from an external database with a query based on the received characterization information.

3. The method according to claim 1, wherein the second characterization information in unvalidated.

4. The method according to claim 3, further comprising analyzing the content a second time using the second characterization information as a constraint on one or more recognition algorithms.

5. The method according to claim 4, wherein analyzing the content a second time either validates or dismisses unvalidated characterization data.

6. The method according to claim 5, wherein validated characterization data is used as metadata tags for the content.

7. The method according to claim 5, wherein validated characterization data is used to retrieve query an external database for more characterization data.

8. The method according to claim 5, further comprising analyzing the content a third time.

9. A system for generating characterization information for multimedia content comprising:
processing logic adapted to apply first characterization information for the content as a constraint on one or more recognition algorithms, and to analyze the content using the one or more recognition algorithms to generate second characterization information.

10. The system according to claim 9, wherein the first characterization information is either received with the content or retrieved from an external database with a query based on the received characterization information.

11. The system according to claim 9, wherein the second characterization information is unvalidated.

12. The system according to claim 11, wherein said processing logic is further adapted to analyze the content a second time using the second characterization information as a constraint on one or more recognition algorithms.

13. The system according to claim 12, wherein said processing logic is adapted to validate or dismiss the second characterization information during the second analysis.

14. The system according to claim 13, wherein said processing logic is adapted to query an external database based on the validated characterization data.

15. The system according to claim 13, wherein said processing logic is adapted to analyze the content a third time.
